(19) United States
(12) Patent Application Publication
(10) Pub. No.: US 2013/0076652 A1
(43) Pub. Date: Mar. 28, 2013

(54) MAGNETICALLY PERMEABLE HAPTIC MATERIAL

(71) Applicant: Omar Sze Leung, Palo Alto, CA (US)

(72) Inventor: Omar Sze Leung, Palo Alto, CA (US)

(73) Assignee: Apple, Inc., Cupertino, CA (US)

(21) Appl. No.: 13/247,994

(22) Filed: Sep. 28, 2011

(51) Int. Cl. G08B 6/00; H01F 41/06; G06F 3/041

(52) U.S. Cl. 345/173; 340/407.1; 29/605

(57) ABSTRACT

Embodiments may take the form of a haptic device having a ferro magnetic member coupled to a spring. An electromagnet is proximately located to the magnetic member and configured to magnetically attract the first magnetic member when actuated. A magnetically permeable material is positioned between the electromagnet and the first magnetic member.

### TECHNICAL FIELD

The present disclosure generally relates to haptics device and, more particularly, to magnetically permeable materials in haptic devices.

### BACKGROUND

Devices that generate tactile feedback for user's sense of touch are haptic devices. One of the most common forms of haptic feedback is vibration and haptic feedback devices are commonly used as alert devices for mobile devices and video game controllers, for example.

Haptic vibrators may take different forms, such as rotating eccentric weights and linear vibrators. Generally, rotating eccentric weights generate a vibration by spinning a shaft and attached weight having a center of mass offset from the axis of rotation. Traditional linear vibrators use a solenoid actuator with a moving core or a moving voice coil with a permanent magnet. These vibrator designs, however, do not generally emphasize amplitude over other considerations. For example, traditional linear vibrators emphasized linearity of motion over amplitude of tactile feedback. This emphasis reduces the effectiveness of the haptic vibrators, as they may be unable to provide sufficient amplitude for the vibrations to be easily detected when the device having the haptic vibrator is not in a user's hand (e.g., in the user's pocket).

### SUMMARY

Generally, an electromagnetic haptic device and methods related thereto are described that allow for tactile feedback to users. One embodiment may take the form of a haptic device having a ferro magnetic member coupled to a spring. An electromagnet is proximately located to the magnetic member and configured to magnetically attract the first magnetic member when actuated. A magnetically permeable material is positioned between the electromagnet and the first magnetic member.

Another embodiment may take the form of a method of manufacturing a haptic device. The method may include forming parallel magnetically conductive cores and winding wires about each core. The method also includes adhering a magnetically permeable material to each of the cores and positioning a metal plate adjacent to the magnetically permeable material. The metal plate is configured to move relative to the cores. Further, the method includes coupling a spring to the metal plate.

Yet another embodiment may take the form of a trackpad having a first surface for receiving user input and providing haptic feedback and a haptic device configured to transmit haptic feedback though the first surface. The haptic device may include a plurality of magnetically conductive cores. Each core has conductive wires wound thereabout. A magnetically permeable material is coupled to the cores and a metal plate is located adjacent to the magnetically permeable material and configured to move relative to the cores. A spring is coupled between the metal plate and the trackpad.

Still another embodiment may take the form of a method of operating a haptic device that includes providing an first electrical current through a first fixed solenoid to generate a first magnetic field in a first core and providing a second electrical current through a second fixed solenoid to generate a second magnetic field in a second core. The first and second cores are parallel and the poles of the first and second cores are oppositely oriented. The method includes directing at least a portion of the first and second magnetic fields through a magnetically permeable member and displacing a ferro-magnetic member toward the first and second cores, the ferro-magnetic member being coupled to a device by a spring. The method additionally includes stopping the first and second electrical currents so that the first and second magnetic fields stop and

returning the ferro-magnetic member towards a resting position using the spring. The displacement and return of the ferro-magnetic member generates a tactile feedback in the device.

While multiple embodiments are disclosed, still other embodiments of the present invention will become apparent to those skilled in the art from the following Detailed Description. As will be realized, the embodiments are capable of modifications in various aspects, all without departing from the spirit and scope of the embodiments. Accordingly, the drawings and detailed description are to be regarded as illustrative in nature and not restrictive.

### BRIEF DESCRIPTION OF THE DRAWINGS

FIG. 1A illustrates an example haptic device with magnetically permeable material.

FIG. 1B illustrates another example haptic device with magnetically permeable material in accordance with an alternative embodiment.

FIG. 2 illustrates the haptic device of FIG. 1 showing magnetic flux lines through the magnetically permeable material.

FIG. 3 illustrates magnetic flux lines of a haptic device when no magnetically permeable material is present.

FIG. 4 illustrates a metal plate of the haptic device impacting an electromagnet when no magnetically permeable material is present.

FIG. 5 illustrates an obstruction entering between a metal plate and electromagnet of a haptic device when no magnetically permeable material is present.

FIG. 6 illustrates the haptic device of FIG. 1 when a metal plate is pulled towards an electromagnet and compacts the magnetically permeable material.

FIG. 7A illustrates example force profiles for the haptic device of FIG. 1 and a Haptic having only an air gap.

FIG. 7B illustrates an example haptic device having only an air gap.

FIG. 8 is a flowchart illustrating an example method of manufacturing the haptic device of FIG. 1.

FIG. 9 illustrates an example electronic device into which the haptic device of FIG. 1 may be integrated.

### DETAILED DESCRIPTION

Consumer electronic devices including trackpads, videogame controllers, remote controls, mobile phones, smart phones, media players and so forth, all may implement haptic devices to provide tactile feedback. The feedback can take different forms. For example, in a phone, a vibration may indicate an incoming call. On a trackpad, a click or bump may confirm receipt of user input. In a media player, vibration may indicate an alert.

In some cases, however, the tactile feedback may have a rough feel that is not particularly pleasing to a user. For example, with respect to the trackpad, the click or bump may not provide the sensation a user is expecting. Whereas the user may expect a sharp mechanical feel (like that of a mouse click), the haptic device may provide a too soft feel or, alternatively, a too sharp feel. Further, in other cases, the tactile feedback may not be sufficient for a user to notice.

A haptic device is described herein that provides an improved tactile feedback to the user by increasing an amplitude achievable by the haptic device. The increased amplitude may be both easier to sense and may provide a crisper sensation. This is achieved by using a magnetically permeable material to help increase the force of the haptic device and/or possibly increasing a travel distance of a weight of the haptic device. Further, the overly sharp feedback may be avoided by the magnetically permeable material.

Embodiments may take the form of a haptic device having a magnetically permeable material that bridges a gap between an electromagnet and a ferromagnetic material. As used herein, the term “magnetically permeabable material” refers to a material that has a magnetic permeability greater than that of air and is generally greater than 10 Henrys/meter. Further, as used herein the magnetically permeable material is mechanically compliant. As such, the term may refer to ferro gels, ferro fluids, or the like.

The magnetically permeable material lowers the reluctance of the device to improve the efficiency of the device. In a magnetic circuit, reluctance may generally be correlated with resistance in a electrical circuit. That is, like electrical current that follows a path of least resistance, magnetic flux follows the path of least reluctance. Generally, air has low magnetic permeability. The use of the ferromagnetic material eliminates or significantly reduces air gaps in the magnetic circuit. Further, magnetic flux is concentrated through the ferromagnetic material to help increase the magnetic force of the haptic device.

Additionally, the magnetically permeable material allows the gap (for example a gap between a magnet and a moving ferro magnetic member) to be increased and with better gap tolerance. That is, with an air gap, the distance between the operable parts was limited based on the ability of the magnetic force to overcome the reluctance provided by the air. However, with the magnetically permeable material bridging the gap and, thereby reducing the reluctance of the system, the gap may be increased. This provides greater flexibility with respect to the size of the gap or the distance between the component parts. Further, the magnetically permeable material prevents debris obstruction and is mechanically compliant so that it prevents sudden impact between components of the haptic device.

In some embodiments, the electromagnet may take the form of a multi prong magnet, each with a stationary core with stationary windings. In one embodiment in particular, an electromagnet may be provided with two parallel prongs. The parallel prongs may be oriented such that they have opposite polarities directed toward a moving member, such as a metal plate, of a haptic device. That is, one prong may have a positive polarity oriented toward a metal plate, while the other prong may have a negative polarity oriented toward the metal plate. In this configuration, magnetic flux may extend from a first prong, through the magnetically permeable material and moving member to the second prong.

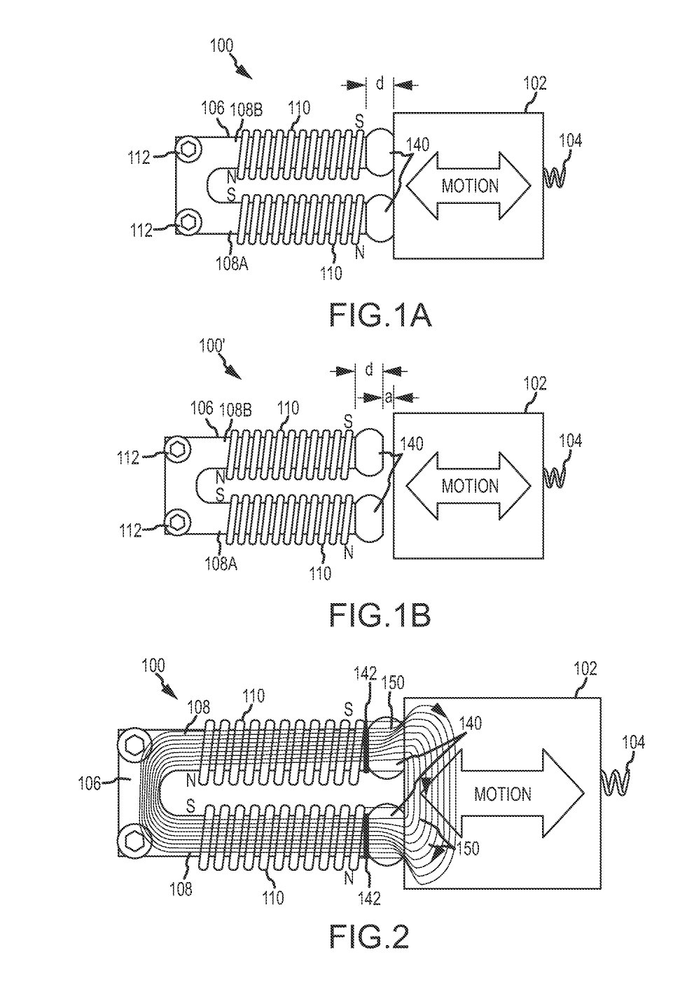

The haptic device may be a linear vibrator 100 that includes a stationary core (e.g., that is rigidly coupled to a housing) in a stationary solenoid as shown in FIG. 1A. The linear vibrator 100 includes a ferromagnetic material, such as metal plate 102, supported by a spring 104. The spring 104 may be coupled to a device for which vibration is to be provided. For example, the spring may be coupled to a haptic surface, such as a haptic trackpad.

A magnetic member, such as electromagnet 106, is located proximately to the metal plate 102. The electromagnet 106 may include parallel metal cores 108, each with conductive wire 110 wound thereabout. The cores 108 may form a rigid unitary member that may be fixed in place with attachment members, such as screws 112. Hence, the cores 108 may be fixed relative to a housing and relative to each other. Further, the wires 110 may be fixed in relation to the cores so that they do no move or cannot easily be displaced. In some embodiments, the conductive wires 110 wound around each of cores may be independent from each other so that each may be addressed individually.

Electrical current may be applied to the conductive wires 110 to generate a magnetic field and actuate the electromagnet. In simple terms, the actuation of the electromagnet 106 attracts the metal plate 102 towards the electromagnet. Upon stopping actuation of the electromagnet, the spring 104 returns the metal plate 102 towards a resting position. Thus, oscillation of the metal plate 102 may be created to generate a vibrating motion in an electronic device.

The parallel metal cores 108 provide a parallel interface that allows both magnetic poles to be oriented toward the metal plate. That is, a first metal core 108A may have north pole oriented toward the metal plate 102, while a second core 108B may have its south pole oriented toward the metal plate. It should be appreciated that the poles are determined based on the direction in which an electrical current flows through the conductive wire 110. As such, the poles of the cores 108A, 108B may be altered without altering the structure of the haptic vibrator 100.

Additionally, the linear vibrator 100 has a magnetically permeable material 140 positioned between the electromagnet 106 and the metal plate 102. The magnetically permeable material 140 may take the form of a ferro fluid, ferro gel, or fluid foam impregnated with magnetic particles, and so on. An adhesive 142 may bond the magnetically permeable material 140 to the core 108. In some embodiments, the magnetically permeable material may additionally or alternatively be bonded to the metal plate 100. In some embodiments, the ferro fluid may be contained within a bubble, sphere, or other shape made of an elastomeric material. The bubble may provide both containment and shape for the ferro fluid.

The use of the magnetically permeable material with the electromagnet may provide increased force through the parallel interface. In a simple horseshoe clapper geometry, the total force can be approximated by

(A*B²)/(μ₀₎. where B is (N*I)²/(Rₜₒₜₐₗ*A)

where N is the number of turns, I is the current, R is reluctance, which can be shown as 2 (L_{magnet} Aₚₐₜₕ/μ_{magnet})+(LₚₐₜₕAₚₐₜₕ/μₛₜₑₑₗ)+(Aₚₐₜₕ/μₘₐₜₑᵣᵢₐₗ)d_{gap}, A is the cross-sectional area of the path of magnetic flux, μ is the permeability of the materials, and d is the distance between the magnet and the steel. It should be appreciated that the foregoing force equation provides an approximation and an actual implementation of the magnet may achieve greater or less force than what may be calculated based on the equation. In particular, environmental factors, size and shape of the components of the electromagnet, and other factors may influence an actual force that may be achieved.

Generally, the reluctance of the steel and the magnet is approximately 2000. The reluctance of a ferro gel or ferro fluid typically may be between 10 and 100, whereas the reluctance of air is approximately 1. Hence, without the ferro gel, if the magnet and steel path is 80 mm and there is an air gap of 1 mm, 99% of the reluctance in the system is due to the air gap and dramatically reduce the amount of force that may be provided. The magnetically permeable material 140 however, eliminates or reduces the air gap and thereby decreases the overall reluctance, allowing for more force with greater efficiency. The greater force and efficiency are achieved by concentrating the magnetic flux through the ferro gel or fluid and thereby lowering the system reluctance. Additionally, the magnetically permeable material prevents contact between the plate and the magnet and prevents debris from entering between the two.

FIG. 1B illustrates another example haptic device 100′ with magnetically permeable material in accordance with an alternative embodiment. Generally, the haptic device 100′ includes the same component parts as the haptic device 100 illustrated in FIG. 1A. However, the haptic device 100′ has an air gap a between the magnetically permeable material 140 and the metal plate 102. Providing the air gap in conjunction with the magnetically permeable material may allow for greater force when pulling the metal plate 102 toward the magnet. It should be appreciated that in other embodiments, the magnetically permeable material may be coupled to the metal plate rather than the electromagnet. Further it should be appreciated that the more than two cores may be provided. For example, in some embodiments, four cores may be provided.

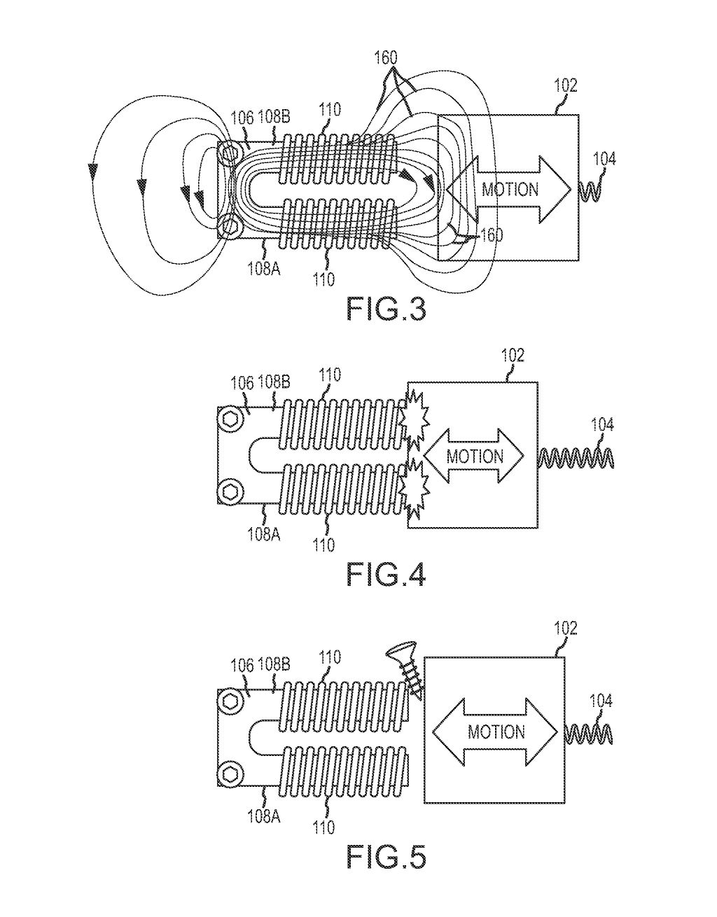

FIG. 2 illustrates example magnetic flux lines 150 as being directed from the cores 108 through the magnetically permeable material 140 and the metal plate 102. The magnetic flux 150 lines are concentrated through the magnetically permeable material 140 due to the higher permeability of the material relative to air. For reference, FIG. 3 illustrates example magnetic flux lines 160 that may be present if no magnetically permeable material is used thus leaving a gap between the electromagnet 106 and the metal plate 102. As may be seen, the flux lines 160 are not concentrated and some run directly between the cores 108A and 108B. Hence, the magnetic forces are not directed toward the metal plate 102 and the effect of the electromagnet is reduced.

Further, without the magnetically permeable material 140 the linear vibrator 100 may be susceptible to several issues other than reduced magnetic forces. One such issue is illustrated in FIG. 4 with the metal plate 102 traveling past a threshold, contacting the electromagnet 106 and creating a hard landing. Another issue is illustrated in FIG. 5 where debris, especially magnetically attracted items, may become located between the metal plate 102 and the electromagnet 106, thereby obstructing movement of the metal plate.

Accordingly, beyond the increase in force and efficiency of the electromagnet 106, other advantages may be realized through use of the magnetically permeable material in the haptic device 100. Examples may include preventing contact between the electromagnet 106 and the metal plate 102 (shown in FIG. 4), robustness against contaminations/obstructions (shown in FIG. 5), increased amplitude of the haptic device, increased distance between the electromagnet and the metal plate, smaller magnet size, and error tolerance. The increased amplitude may be achieved through the increased force and/or increase travel distance of the metal plate. The smaller magnet may allow the haptic device to fit into smaller spaces. The increased error tolerance may help to reduce production costs as more devices would fall within the acceptable tolerances.

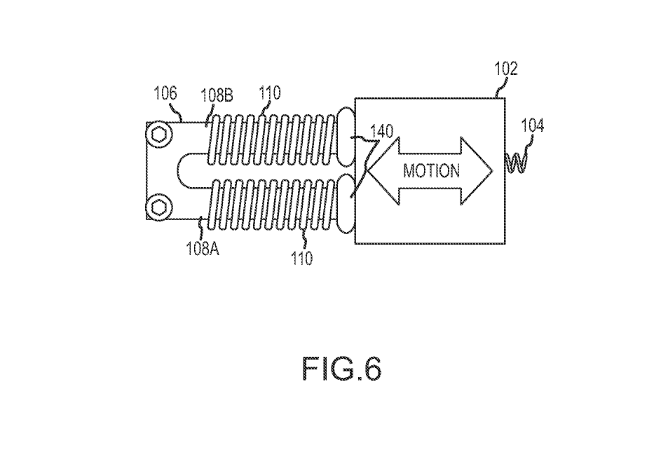

FIG. 6 illustrates movement of the metal plate 102 towards the electromagnet 106, thereby causing displacement of the magnetically permeable material. As the magnetically permeable material 140 is squished, due to the magnetic forces pulling the metal plate 102 toward the electromagnet 106, the magnetic force spreads out and decreases. That is, the magnetic forces become less concentrated. As such, the force profile is unique from devices in which no magnetically permeable material is provided.

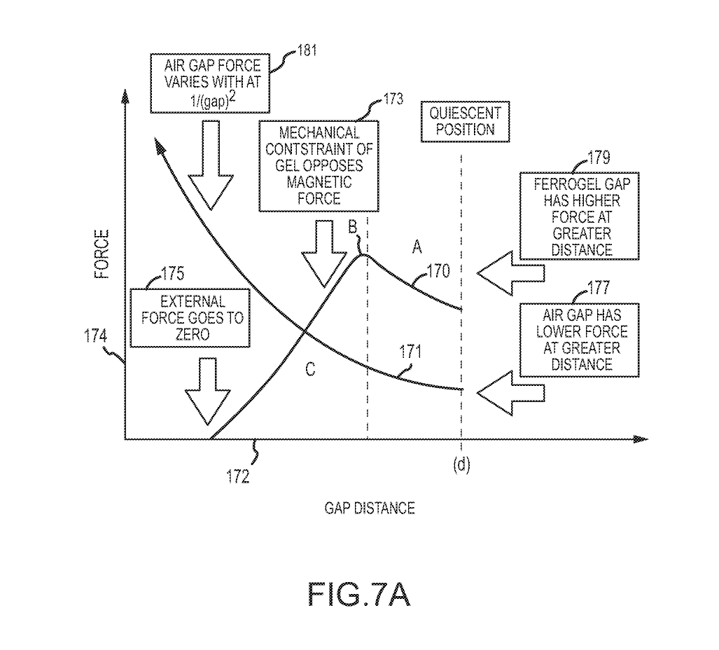

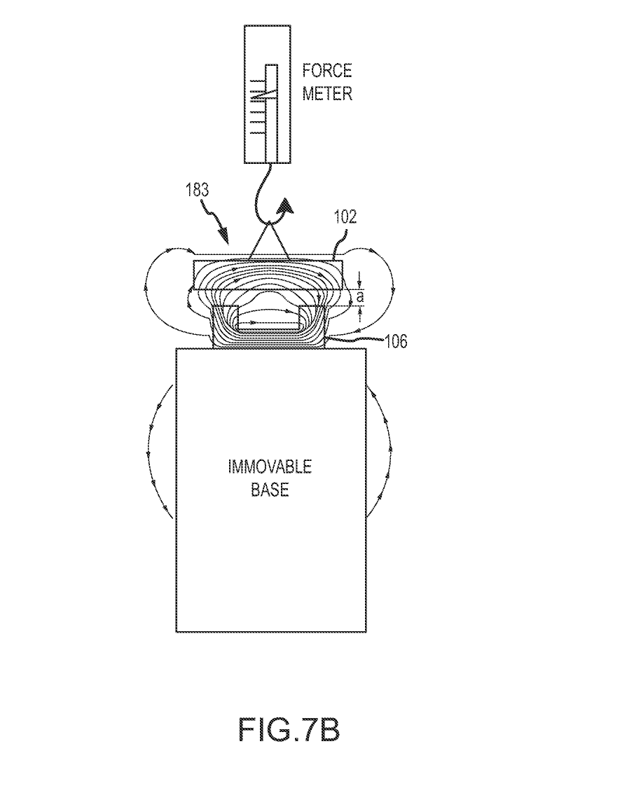

Example force profiles 170 and 171 are illustrated in FIG. 7A. The first profile 170 represents the force profile of an embodiment implementing the ferro gel, as illustrated in FIG. 1A. The second profile 171 represents the force profile of a device 183 having only an air gap, as shown in FIG. 7B. It should be appreciated that the profile 170 is presented primarily to give a sense of the force profile and may approximate a profile achievable using various different magnitudes of force and across varied distances. The horizontal axis 172 represents the distance of the metal plate 102 from the electromagnet 106 (or gap distance) and the vertical axis 174 represents the magnetic force pulling the metal plate 102 towards the electromagnet 106.

Referring first to the force profile 170 of the haptic device with ferro gel. The metal plate 102 may be at rest at a distance d from the origin. This is the quiescent position of the metal plate. As may be seen, the magnetic force increases rapidly through a first region A as the metal plate approaches the electromagnet, then reaches a threshold distance B, after which the force decreases in region C. The force diminishes in region C because of gel compression (Block 173). Eventually, the external force goes to zero (Block 175). It should be appreciated that the profile 170 is presented as an example and may approximate a profile achievable in various different magnitudes of force and across varied distances. In certain embodiments, the profile 170 may take a different shape. In the haptic device example, the displacement of the metal plate 102 may be between 50-500 micrometers. This is measured from the quiescent state to the maximum deflection.

Turning to the profile 171 of the haptic device 183 with only an air gap. As may be seen in the quiescent position, there is much less force (Block 177) compared to the ferro gel embodiment (Block 179). However, as the metal plate 102 is pulled closer to the magnet, the force continually increases at a rate of 1/(gap²) as shown (Block 181)

Thus, the metal plate 102 cannot reach the parallel interface of the cores due to the magnetically permeable material. That is, the magnetically permeable material has a threshold compaction that the metal plate cannot pass through. As such the force profile stops short of the reaching the vertical axis.

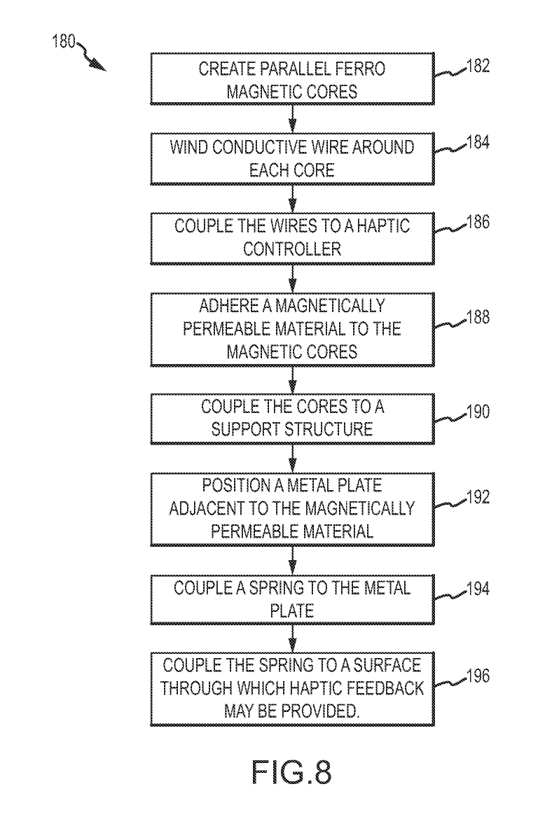

FIG. 8 is a flowchart illustrating an example method of manufacturing 180 a haptic device using the magnetically permeable material. Parallel ferro magnetic cores are created (Block 182). The parallel cores may be formed as a unitary structure in some embodiments. In other embodiments, the cores may be rigidly coupled to a bridging member that maintains the distance as well as the parallel orientation of the cores relative to each other. Conductive wire is wound around the parallel cores (Block 184) and the conductive wires are electrically coupled to a haptic controller (Block 186).

The method further includes adhering a magnetically permeable material to the magnetic cores (Block 188) and coupling the ferro-magnetic cores to a support structure (Block 190). For example, the cores may be rigidly coupled to a device housing. A metal plate is positioned adjacent to the magnetically permeable material so that the magnetically permeable material is located between the metal plate and the magnetic cores in a manner that allows for displacement of the metal plate relative to the cores (Block 192). It should be appreciated that alternatively or additionally, the magnetically permeable material may be adhered to the metal plate. A spring may be coupled to the metal plate (Block 194) and the spring is coupled to a surface through which haptic feedback may be provided (Block 196).

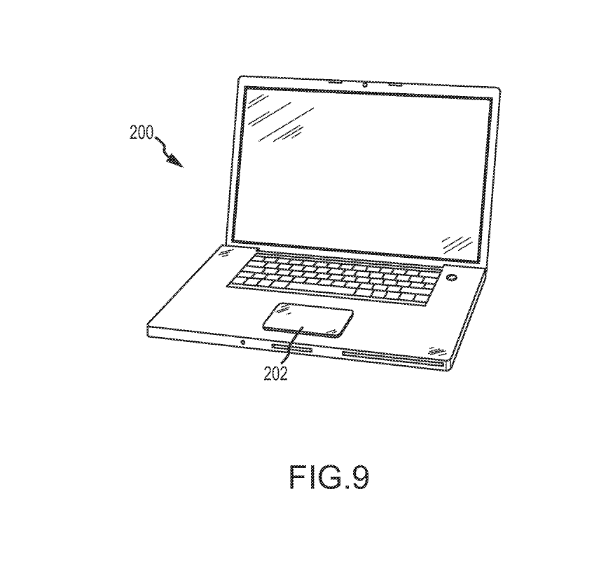

FIG. 9 illustrates an example electronic device 200 in which a the haptic device 100 may be implemented. Specifically, the haptic device 100 may be implemented as part of a haptic feedback system for the track pad 202 of the device 200. In this example, the exposed surface of the trackpad may provide a user interface surface and the haptic device may be obscured from the users view by the exposed surface or another surface of the device 200. However, the spring 104 of the haptic device may be coupled to the track pad so that haptic feedback may be provided through the exposed surface. It should be appreciated, that the magnetically permeable material with the electromagnet may be implemented in a variety of different devices and may have may different application. For example, it may be implemented where increased force may be desired, such as on a door, on keys that use haptics, clicking devices, and/or bell ringers.

The foregoing describes some example embodiments of a haptic device having a magnetically permeable material. Although the foregoing discussion has presented specific embodiments, persons skilled in the art will recognize that changes may be made in form and detail without departing from the spirit and scope of the embodiments. For example, in some embodiments, the magnetically permeable material may be held in place magnetically, with a friction fit or by enclosing a portion of the haptic device. Accordingly, the specific embodiments described herein should be understood as examples and not limiting the scope thereof.

1. A haptic device comprising:
a ferro magnetic member coupled to a spring;
an electromagnet proximately located to the magnetic member, wherein the electromagnet is configured to magnetically attract the ferro magnetic member when actuated; and
a magnetically permeable material positioned between the electromagnet and the ferro magnetic member.

2. The haptic device of claim 1, wherein the magnetically permeable material comprises a ferro gel.

3. The haptic device of claim 1, wherein the magnetically permeable material comprises a ferro fluid.

4. The haptic device of claim 1, wherein the electromagnet comprises a stationary core.

5. The haptic device of claim 1, wherein the electromagnet comprises a stationary solenoid.

6. The haptic device of claim 1, wherein the electromagnet comprises two prongs.

7. The haptic device of claim 6, wherein the prongs have a generally parallel orientation.

8. The haptic device of claim 6, wherein the two prongs are configured so that a first prong is oriented with a positive pole oriented toward the ferro magnetic member and a second prong is oriented with a negative pole oriented toward the ferro magnetic member.

9. The haptic device of claim 6, wherein the two prongs are mechanically coupled together.

10. The haptic device of claim 6, wherein the two prongs form a unitary member.

11. The haptic device of claim 1, wherein the spring is coupled to a haptic surface.

12. The haptic device of claim 11, wherein the haptic surface comprises a haptic trackpad.

13. The haptic device of claim 1, wherein the ferro magnetic member comprises a metal plate.

14. The haptic device of claim 1, wherein the magnetically permeable material is adhered to the electromagnet.

15. The haptic device of claim 1, wherein the magnetically permeable material is adhered to the ferro magnetic member.

16. A method of manufacturing a haptic device comprising:
forming parallel magnetically conductive cores;
winding wires about each core;
adhering a magnetically permeable material to each of the cores;
positioning a metal plate adjacent to the magnetically permeable material, wherein the metal plate is configured to move relative to the cores; and
coupling a spring to the metal plate.

17. The method of claim 16, wherein forming parallel magnetically conductive cores comprises forming a unitary member.

18. The method of claim 16, wherein winding wires about each core comprises winding a first wire around a first core and a second wire around a second core.

19. The method of claim 16 further comprising adhering the magnetically permeable core to the metal plate.

20. A trackpad comprising:
a first surface for receiving user input and providing haptic feedback;
a haptic device configured to transmit haptic feedback though the first surface, wherein the haptic device comprises:
a plurality of magnetically conductive cores, wherein each core has conductive wires wound thereabout;
a magnetically permeable material coupled to the cores;
a metal plate located adjacent to the magnetically permeable material and configured to move relative to the cores; and
a spring coupled between the metal plate and the trackpad.

21. The trackpad of claim 20, wherein the haptic device comprises four magnetically conductive cores.

22. A method of operating a haptic device comprising:
providing an first electrical current through a first fixed solenoid to generate a first magnetic field in a first core;
providing a second electrical current through a second fixed solenoid to generate a second magnetic field in a second core, wherein the first and second cores are parallel and the poles of the first and second cores are oppositely oriented;
directing at least a portion the first and second magnetic fields through a magnetically permeable material;
displacing a ferro-magnetic member toward the first and second cores, the magnetically permeable member being located between the ferro-magnetic member and the first and second cores, and the ferro-magnetic member being coupled to a device by a spring;
stopping the first and second electrical currents so that the first and second magnetic fields stop; and
returning the ferro-magnetic member towards a resting position using the spring, wherein the displacement and return of the ferro-magnetic member generates a tactile feedback in the device.

23. The method of claim 22, wherein the first and second current comprise the same current.
